(19) United States
(12) Patent Application Publication
(10) Pub. No.: US 2003/0216852 A1
(43) Pub. Date: Nov. 20, 2003

(54) Smarti

(76) Inventor: Caroll A. Wilson, Dublin, OH (US)

Correspondence Address: Caroll A. Wilson, 6939 Gullway Bay Dr, Dublin, OH, 43017, US

(21) Appl. No.: 09/919,513

(22) Filed: May 16, 2002

(51) Int. Cl. G06F 7/00; B60T 8/32

(52) U.S. Cl. 701/93; 340/426.16

(57) ABSTRACT

A method for which the speed of an automobile is determined and manipulated by the Smarti remote control system. A programmable speed monitoring device system includes a remote control unit, a receiving unit, and an operation unit connected to the automobiles standard electronic and fuel system.

First, the information determining the maximum speed of the vehicle is determined and inputted into the Smarti remote control. Prior to the remote accepting any data, the correct combination code must be entered by the owner/operator. Once all data is properly entered into the remote, the remote signals the receiving unit. Once the receiving unit has received and read the data, it then sends the speed restriction data to the operation unit. For example, when the owner/operator inputs the security info and the maximum speed information, the Smarti transmits that data to the receiving and operation units that will in turn regulate the automobiles fuel pressure, thus restricting the vehicles speed capability. The Smarti enables the owner/operator the ability to set a predetermined maximum speed, and record the speed of the vehicle while not being present.

### BRIEF DESCRIPTION OF DRAWINGS

FIG. 1 is a flow diagram showing an example of how the speed of the vehicle is maintained and manipulated by the Smarti control. FIG. 2 is a block diagram showing the structure of the Smarti remote control device.

### DETAILED DESCRIPTION OF THE PREFERRED EMBODIMENTS

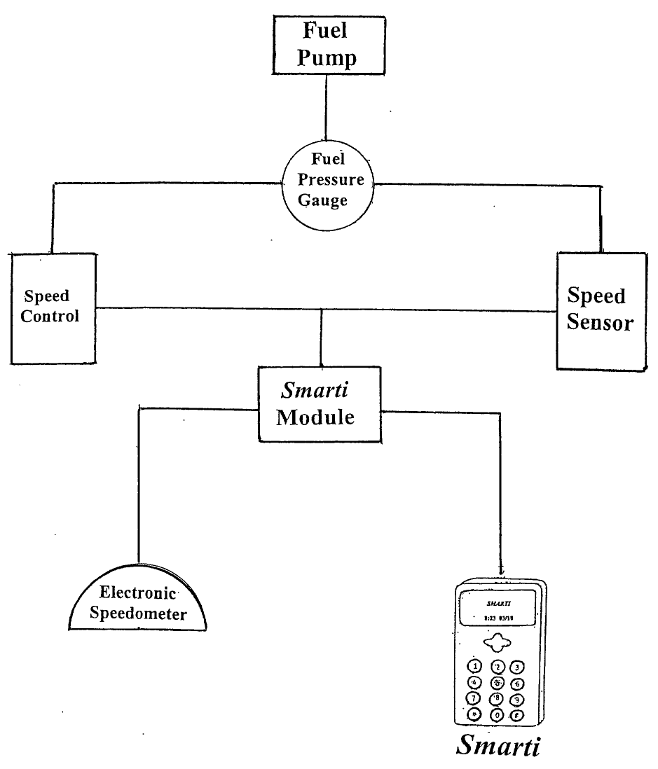

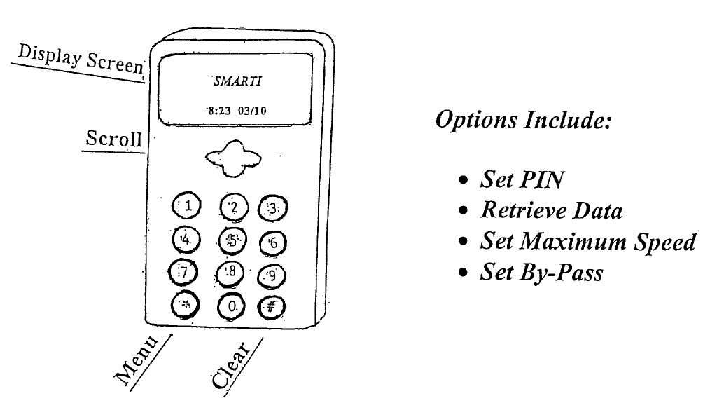

FIG. 1 is a flow diagram illustrating the operational sequence of the Smarti manipulation of the vehicle speed monitoring and regulating system.

The owner/operator inputs the desired information into the Smarti remote control. The data is retrieved and interpreted by the Smarti module. Once the data is read and the predetermined maximum speed is acknowledged, the Smarti module will monitor the speed sensor and speed control. Thus, if the vehicle's speed exceeds the predetermined maximum speed allowance, the fuel system is notified and fuel amount to the engine reduced. The Smarti module will execute the reduction of fuel pressure. The fuel pressure gauge will decrease, and the fuel pump will restrict the amount of fuel to the engine.

FIG. 2 is a block diagram illustrating the structure of the Smarti remote control. Referring again to FIG. 2, the main control unit communicates with the Smarti module. The display unit displays information such as maximum speed allowance, current date and time. The scroll button enables the owner/operator to scroll to the desired data positions quickly. Each position will accept the desired and executed data. The owner/operators personal identification data, settings for the maximum speed desired, and a by-pass feature are a few of the Smarti remote control options.

Referring again to FIG. 2, the Smarti control, referred to as the main unit, sends a signal, corresponding to the predetermined data input, to the Smarti module, which will then relate information to-the-vehicle's-speed control system and the fuel pressure. The vehicle's fuel pressure is then reduced, thus deterring the vehicles speed.

I claim:

1. In a remote control speed monitoring and deterring system for an automobile, comprising a Smarti remote control unit, connected to said receiving unit. The said remote control unit emitting a combination code and the determined maximum speed allowance for the vehicle:
wherein said remote control unit includes a keyboard, combination code and maximum speed data to correspond with the automobile's standard electronic and fuel systems, through the Smarti receiving units.
Wherein said receiving units include the Smarti module and the electronic speedometer, said control means being configured to monitor and deter the speed reached in excessive of the data input into the Smarti remote control device. Control the vehicle's speed and monitoring the vehicle's data.
Control means for controlling the speed of the vehicle by means of the predetermined data entered into the Smarti remote by the owner/operator. The remote sends a signal to the Smarti module that will read and transfer information to the vehicle's fuel pressure system. Once the fuel pressure system receives the message, it reduces the pressure and fuel to the engine.
The control means enabling the owner/operator the ability to record and set the maximum speed of the vehicle by determining and entering the desired data into the Smarti remote.

2. The system of claim 1, wherein in the Smarti remote control accepts the combination code, the maximum desired speed data, and all other data inputted by the owner/operator.

3. The system of claim 1, wherein the Smarti remote control will record and display the vehicle's maximum speed, date and time data.

4. The system of claim 1, wherein the Smarti remote control actuated by the owner/operator corresponds to the computerized Smarti module, located within the vehicle. The signal from the said remote is then transmitted to the vehicle's speed sensor and speed control units.

5. The system of claim 4, wherein the module is installed within the vehicles electronic panel. The signals are received, read and distributed to the speed sensor and speed control components.

6. The system of claim 1, wherein the speed allowance is determined by the owner/operator and in turn manipulated and maintained by the Smarti module.

7. The system of claim 1, wherein the speed recording and monitoring system means is further operative to control the speed allowed by inputting data into the Smarti remote control.

8. The system of claim 1, wherein the operating speed means comprises a remote control.

9. The system of claim 1, wherein the speed control means continues to monitor vehicles maximum speed allowance and deter excessive speed of the predetermined set data.

10. The system of claim 1, wherein the speed control means automatically maintaining predetermined maximum speed allowance.

11. A Smarti, comprising:
A remote control located inside the vehicle; a data input station provided on the remote device to display and allow data input operations to be performed and stored based on the data input into the system.
A Smarti module that receives and interprets the data transmitted from the Smarti remote, then in turn sends the information to the vehicle's speed sensor and speed control units.

12. The system of claim 1, wherein the Smarti module continues to record and maintain the maximum speed allowance.

13. The system of claim 12, wherein the data received by the speed sensor and the speed control is transmitted to the fuel pressure gauge. When the predetermined maximum speed is exceeded, the fuel pressure is reduced.

14. The Smarti module manipulates the system of claim 12, wherein the continued recording and maintaining of the predetermined maximum speed allowance is maintained.

15. The system of claim 13, wherein the predetermined maximum speed is exceeded, the fuel pressure gauge will decrease, decreasing the amount of fuel into the engine. The lack of fuel will prevent the vehicle from exceeding the predetermined maximum speed allowance.

16. The system of claim 1, wherein the Smarti remote control will continue to read vehicle performance, including maximum speed reached, date and time data.

17. A method of controlling and recording a vehicle's maximum speed allowance by utilizing the owner/operator's combination code and determining and programming the Smarti remote control to the specified maximum speed allowance.
Once the owner/operator has programmed the Smarti remote, the Smarti control will record and restrict the vehicle's speed.
If the vehicle reaches the maximum speed allowed, the fuel pressure will decrease, thus reducing the supply of fuel to the vehicle.
The maximum speed allowance cannot be reprogrammed without the owner/operator's combination code data.
The data will remain stored within the Smarti remote control until it has been reset by the owner/operator's combination code data.
